(19) United States
(12) Patent Application Publication
(10) Pub. No.: US 2024/0380913 A1
(43) Pub. Date: Nov. 14, 2024

(54) MOTION COMPENSATION VIA INERTIAL TRACKING AND OPTICAL FLOW

(71) Applicant: Microsoft Technology Licensing, LLC, Redmond, WA (US)

(72) Inventors: Michael BLEYER, Seattle, WA (US); Christian Markus MAEKELAE, Redmond, WA (US); Christopher Douglas EDMONDS, Carnation, WA (US)

(21) Appl. No.: 18/314,370

(22) Filed: May 9, 2023

(51) Int. Cl. H04N 19/51; G06T 3/00; G06T 3/40; G06T 5/50

(52) U.S. Cl. CPC H04N 19/51; G06T 3/02; G06T 3/40; G06T 5/50; G06T 2207/20221

(57) ABSTRACT

A system for facilitating motion compensation is configurable to access an affine transformation-compensated image. The affine transformation-compensated image is generated by applying affine transformation-based motion compensation to a previous image. The system is further configurable to generate a motion-compensated image by applying optical flow-based motion compensation to the affine transformation-compensated image. The optical flow-based motion compensation utilizes the affine transformation-compensated image and a current image as inputs.

### BACKGROUND

Mixed-reality (MR) systems, including virtual-reality and augmented-reality systems, have received significant attention because of their ability to create truly unique experiences for their users. For reference, conventional virtual reality (VR) systems create a completely immersive experience by restricting their users' views to only a virtual environment. This is often achieved, in VR systems, through the use of a head-mounted device (HMD) that completely blocks any view of the real world. As a result, a user is entirely immersed within the virtual environment. In contrast, conventional augmented-reality (AR) systems create an augmented-reality experience by visually presenting virtual objects that are placed in or that interact with the real world.

As used herein, VR and AR systems are described and referenced interchangeably. Unless stated otherwise, the descriptions herein apply equally to all types of mixed-reality systems, which (as detailed above) includes AR systems, VR reality systems, and/or any other similar system capable of displaying virtual objects.

Some MR systems include one or more cameras and utilize images and/or depth information obtained using the camera(s) to provide pass-through views of a user's environment to the user. A pass-through view can aid users in avoiding disorientation and/or safety hazards when transitioning into and/or navigating within a mixed-reality environment. Pass-through views may also enhance user views in low-visibility environments. For example, mixed-reality systems configured with long-wavelength thermal imaging cameras may facilitate visibility in smoke, haze, fog, and/or dust. Likewise, mixed-reality systems configured with low-light imaging cameras facilitate visibility in dark environments where the ambient light level is below the level required for human vision.

An MR system may provide pass-through views in various ways. For example, an MR system may present raw images captured by the camera(s) of the MR system to a user. In other instances, an MR system may modify and/or reproject captured image data to correspond to the perspective of a user's eye to generate pass-through views. An MR system may modify and/or reproject captured image data to generate a pass-through view using depth information for the captured environment obtained by the MR system (e.g., using a depth system of the MR system, such as a time of flight camera, a rangefinder, stereoscopic depth cameras, etc.). In some instances, an MR system utilizes one or more predefined depth values to generate pass-through views (e.g., by performing planar reprojection).

In some instances, pass-through views generated by modifying and/or reprojecting captured image data may at least partially correct for differences in perspective brought about by the physical separation between a user's eyes and the camera(s) of the MR system (known as the “parallax problem,” “parallax error,” or, simply “parallax”). Such pass-through views/images may be referred to as “parallax-corrected pass-through” views/images. By way of illustration, parallax-corrected pass-through images may appear to a user as though they were captured by cameras that are co-located with the user's eyes.

Pass-through imaging can provide various beneficial user experiences, such as enabling users to perceive their surroundings in situations where ordinary human perception is limited. For instance, an MR system may be equipped with thermal cameras and be configured to provide pass-through thermal imaging, which may enable users to perceive objects in their environment even when smoke or fog is present. As another example, an MR system may be equipped with low light cameras and be configured to provide pass-through low light imaging, which may enable users to perceive objects in dark environments.

In the example of low light imaging conditions, individual image frames captured by an image sensor may fail to capture sufficient scene information to provide an interpretable image to the user. When the image sensor is implemented on a moving user device, such as an MR system, implementing a long exposure time to enable an image frame to capture additional scene information can result in blurred images (e.g., brought about by motion of the image sensor during image capture).

Accordingly, many low light image sensors operate by capturing temporally consecutive image frames and combining the consecutive image frames to generate output imagery for display to a user. Many systems perform motion compensation to account for motion of the image sensor while capturing the temporally consecutive image frames. For instance, inertial tracking data may be obtained while capturing consecutive image frames, and the inertial tracking data may be used to align the consecutive image frames (e.g., to a current position, or to a position at which output imagery will be displayed). The aligned image frames may then be combined from output imagery that includes more scene information than an individual image frame could provide on its own.

The subject matter claimed herein is not limited to embodiments that operate only in environments such as those described above. Rather, this background is only provided to illustrate one example technology area where some embodiments described herein may be practiced.

### BRIEF DESCRIPTION OF THE DRAWINGS

To describe how the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered limiting in scope, embodiments will be described and explained with additional specificity and detail through the use of the accompanying drawings in which:

FIG. 1 illustrates example components of an example system that may include or be used to implement one or more disclosed embodiments.

FIG. 2A illustrates a conceptual representation of a current image of objects within a scene at a current timepoint captured by an HMD camera.

FIG. 2B illustrates a conceptual representation of a previous image of the scene acquired by the HMD in association with a previous timepoint and conceptually depicts motion that occurred from the previous timepoint to the current timepoint.

FIG. 3A illustrates a conceptual representation of applying affine transformation-based motion compensation to the previous image of FIG. 2B to obtain an affine transformation-compensated image.

FIG. 3B illustrates a conceptual representation of determining optical flow between the affine transformation-compensated image and the current image from FIG. 2A.

FIG. 3C illustrates a conceptual representation of applying the optical flow to the affine transformation-compensated image to obtain a motion-compensated image.

FIG. 3D illustrates a conceptual representation of generating an output image using the motion-compensated image and the current image.

FIGS. 4, 5, and 6 illustrate example flow diagrams depicting acts associated with facilitating motion compensation, in accordance with implementations of the present disclosure.

### DETAILED DESCRIPTION

Disclosed embodiments are generally directed to systems, methods, and apparatuses for facilitating motion compensation via inertial tracking and optical flow.

### Examples of Technical Benefits, Improvements, and Practical Applications

As noted above, many image sensors operate by acquiring temporally consecutive image frames and combining the consecutive image frames to generate output imagery for display to a user. A previous image frame can be combined with a current image frame (e.g., in a weighted manner) to provide the output image. In some instances, the previous image frame comprises a previously generated output image, such only two images are used in the image processing pipeline. Upon acquisition of a new output image, the new output image can be stored for use as a previous image to be combined with a subsequently captured image frame to generate a subsequent output image.

To facilitate alignment of a previous image frame and a current image frame, many systems perform motion compensation to account for motion of the image sensor during image capture. Often, inertial tracking data is obtained during image capture, and the inertial tracking data is used to align the temporally consecutive image frames. In some implementations, inertial tracking data is acquired using an inertial measurement unit (IMU), which may comprise one or more accelerometers, gyroscopes, magnetometers, etc. Inertial tracking data often indicates 3D rotation data (e.g., in three degrees of freedom, namely pitch, roll, and yaw) and fails to indicate 3D translational data. Thus, relying solely on inertial tracking data to facilitate motion compensation can fail to account for translational movements of the image sensor during image capture (e.g., when a user is walking), which can result in artifacts in output imagery (e.g., blurring artifacts).

Some motion compensation solutions acquire pose information in six degrees of freedom (6DOF), such as by performing simultaneous localization and mapping (SLAM) and/or other pose tracking techniques. Although such pose information may be utilized to facilitate motion compensation in a more robust manner than relying on inertial tracking data alone, such techniques rely on additional sensor hardware (e.g., depth sensing functionality) and/or computational steps (e.g., feature detection to facilitate environment mapping). Such techniques are therefore unsuitable for many use cases, such as where hardware and/or computational constraints exist.

At least some disclosed embodiments are directed to motion compensation techniques that utilize inertial tracking data and optical flow computation. In one example, pixels of a previous frame are remapped to a current position using a motion model obtained based upon inertial tracking data to obtain an affine transformation-compensated frame. Optical flow computations are then performed on the affine transformation-compensated frame to compensate for translation. By combining inertial tracking-based motion compensation with optical flow-based motion compensation, the disclosed techniques may facilitate motion compensation that accounts for translation and rotation with limited hardware and/or computational requirements (e.g., compared to systems that rely on depth information and 6DOF pose information).

In some implementations, the optical flow computation is performed at a low image resolution (e.g., after downsampling the affine transformation-compensated frame), which can help to mitigate image noise and quantization. In some implementations, the optical flow computation obtains a single motion model for the whole affine transformation-compensated frame, rather than calculating a separate motion model for each individual pixel of the affine transformation-compensated frame. Relative to conventional techniques that obtain a separate motion model for each pixel, utilizing a single motion model for the whole image can be more computationally efficient and can facilitate more robust optical flow computation in very low signal-to-noise scenarios (e.g., in low light conditions).

In some instances, optical flow computations of the disclosed embodiments utilize a three-parameter framework, rather than a 6-parameter framework as utilized in conventional optical flow computations. For instance, conventional 6-parameter affine models allow modeling of rotation, shearing, translation, and scaling. However, in very low signal images, the 6 parameters can cause computing of an optical flow solution that aligns two images based primarily on image noise. Such motion models can cause wobble artifacts in output imagery, which can undermine user experiences.

Thus, at least some disclosed embodiments reduce the number of parameters by omitting rotational modeling (e.g., because rotation is handled via inertial tracking-based motion compensation) and shear modeling. This can result in a 3-parameter that includes translation in two dimensions (e.g., x translation and y translation) and scaling. Such a 3-parameter model may be regarded as a zoom model, which corresponds to the dominant 3D motion when a user is walking. Such a 3-parameter model may be written as a 3×3 matrix (s, 0, tₓ; 0, s, t_{y}; 0, 0, 1), where s represents scale, tₓ represents translation in one dimension (i.e., the horizontal or x dimension), and t_{y} represents translation in another dimension (i.e., the vertical or y dimension). Utilizing a 3-parameter model can reduce wobble artifacts by mitigating the possibility of the optical flow solution being determined primarily based upon image noise.

Furthermore, at least some disclosed embodiments utilize a prior in the optical flow computation that biases the solution toward inertial tracking-based compensation only when the input imagery has a low or non-existent signal. Such functionality can be achieved by adding one or more equations to the optical flow computation that indicate that the flow vector at a particular pixel should be identical to the corresponding flow vector derived from the inertial tracking-based motion model only. In some instances, weighting is added to the equation(s) to balance their influence against the other pre-existing components of the optical flow computation. By computing the optical flow solution in a least-squared sense, solutions that are close to the inertial tracking-based solution can be favored. Such functionality can mitigate artifacts that would arise from computing unmitigated optical flow solutions for low signal input images.

Although at least some examples herein are focused, in at least some respects, on facilitating motion compensation of HMD imagery, one will appreciate, in view of the present disclosure, that the principles discussed herein may be applied to facilitate motion compensation of any type of imagery (e.g., images captured by a mobile electronic device, smartphone, tablet, smartwatch, drone, autonomous vehicle, etc.).

### Example Systems and Components

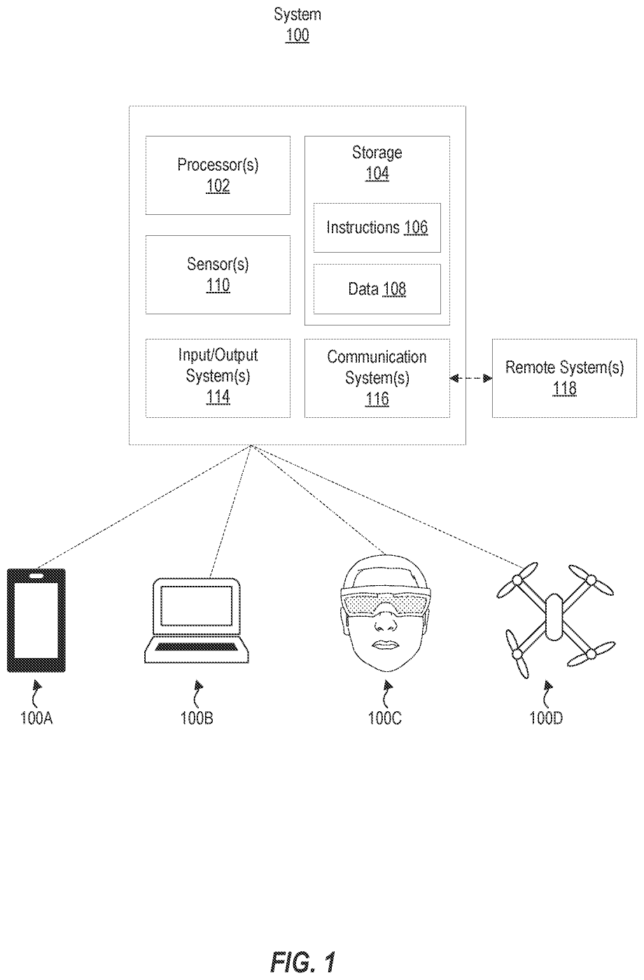

FIG. 1 illustrates various example components of a system 100 that may be used to implement one or more disclosed embodiments. For example, FIG. 1 illustrates that a system 100 may include processor(s) 102, storage 104, sensor(s) 110, input/output system(s) 114 (I/O system(s) 114), and communication system(s) 116. Although FIG. 1 illustrates a system 100 as including particular components, one will appreciate, in view of the present disclosure, that a system 100 may comprise any number of additional or alternative components.

The processor(s) 102 may comprise one or more sets of electronic circuitries that include any number of logic units, registers, and/or control units to facilitate the execution of computer-readable instructions (e.g., instructions that form a computer program). Such computer-readable instructions may be stored within storage 104. The storage 104 may comprise physical system memory and may be volatile, non-volatile, or some combination thereof. Furthermore, storage 104 may comprise local storage, remote storage (e.g., accessible via communication system(s) 116 or otherwise), or some combination thereof. Additional details related to processors (e.g., processor(s) 102) and computer storage media (e.g., storage 104) will be provided hereinafter.

In some implementations, the processor(s) 102 may comprise or be configurable to execute any combination of software and/or hardware components that are operable to facilitate processing using machine learning models or other artificial intelligence-based structures/architectures. For example, processor(s) 102 may comprise and/or utilize hardware components or computer-executable instructions operable to carry out function blocks and/or processing layers configured in the form of, by way of non-limiting example, single-layer neural networks, feed forward neural networks, radial basis function networks, deep feed-forward networks, recurrent neural networks, long-short term memory (LSTM) networks, gated recurrent units, autoencoder neural networks, variational autoencoders, denoising autoencoders, sparse autoencoders, Markov chains, Hopfield neural networks, Boltzmann machine networks, restricted Boltzmann machine networks, deep belief networks, deep convolutional networks (or convolutional neural networks), deconvolutional neural networks, deep convolutional inverse graphics networks, generative adversarial networks, liquid state machines, extreme learning machines, echo state networks, deep residual networks, Kohonen networks, support vector machines, neural Turing machines, and/or others.

As will be described in more detail, the processor(s) 102 may be configured to execute instructions 106 stored within storage 104 to perform certain actions. The actions may rely at least in part on data 108 stored on storage 104 in a volatile or non-volatile manner.

In some instances, the actions may rely at least in part on communication system(s) 116 for receiving data from remote system(s) 118, which may include, for example, separate systems or computing devices, sensors, and/or others. The communications system(s) 116 may comprise any combination of software or hardware components that are operable to facilitate communication between on-system components/devices and/or with off-system components/devices. For example, the communications system(s) 116 may comprise ports, buses, or other physical connection apparatuses for communicating with other devices/components. Additionally, or alternatively, the communications system(s) 116 may comprise systems/components operable to communicate wirelessly with external systems and/or devices through any suitable communication channel(s), such as, by way of non-limiting example, Bluetooth, ultra-wideband, WLAN, infrared communication, and/or others.

FIG. 1 illustrates that a system 100 may comprise or be in communication with sensor(s) 110. Sensor(s) 110 may comprise any device for capturing or measuring data representative of perceivable or detectable phenomenon. By way of non-limiting example, the sensor(s) 110 may comprise one or more radar sensors (as will be described in more detail hereinbelow), image sensors, microphones, thermometers, barometers, magnetometers, accelerometers, gyroscopes, and/or others.

Furthermore, FIG. 1 illustrates that a system 100 may comprise or be in communication with I/O system(s) 114. I/O system(s) 114 may include any type of input or output device such as, by way of non-limiting example, a touch screen, a mouse, a keyboard, a controller, and/or others, without limitation. For example, the I/O system(s) 114 may include a display system that may comprise any number of display panels, optics, laser scanning display assemblies, and/or other components.

FIG. 1 conceptually represents that the components of the system 100 may comprise or utilize various types of devices, such as mobile electronic device 100A (e.g., a smartphone), personal computing device 100B (e.g., a laptop), a mixed-reality head-mounted display 100C (HMD 100C), an aerial vehicle 100D (e.g., a drone), other devices (e.g., self-driving vehicles), combinations thereof, etc. A system 100 may take on other forms in accordance with the present disclosure.

### Motion Compensation Via Inertial Tracking and Optical Flow

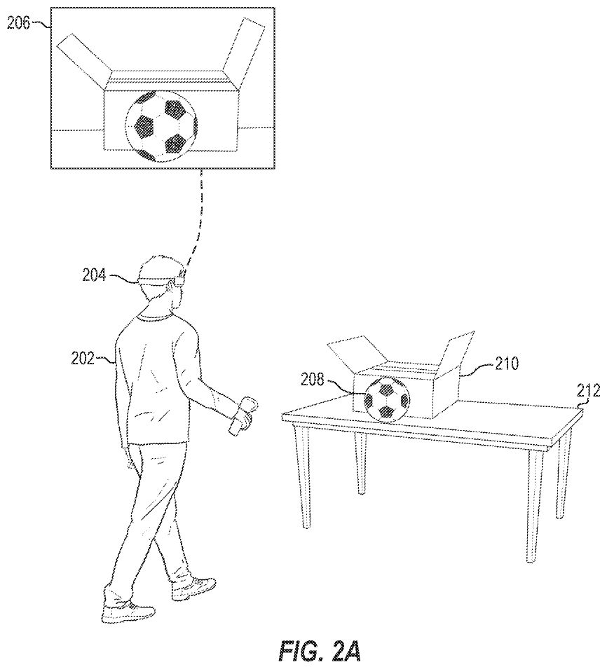

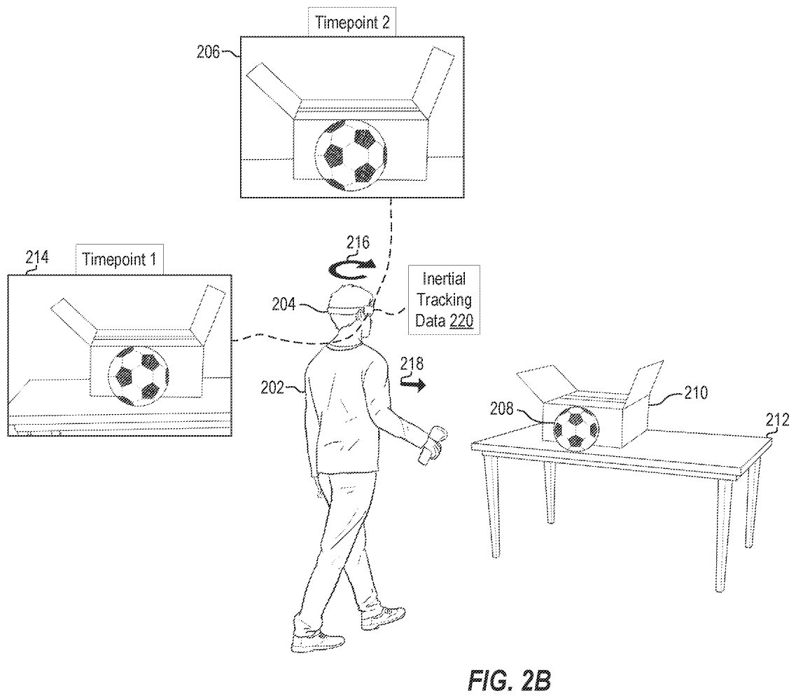

FIG. 2A illustrates an example use case where a user 202 operates a head-mounted display 204 (HMD 204) as part of a mixed reality experience. The HMD 204 may comprise various components of a system 100. For instance, in the example of FIG. 2A, the HMD 204 includes one or more image sensors (e.g., sensor(s) 110) that capture an image 206 of the environment. In the example of FIG. 2A, the image 206 captures portions of a ball 208, a box 210, and a table 212 positioned within the environment near the user 202. The HMD 204 may acquire imagery of the surrounding environment for various purposes, such as to facilitate pass-through imaging or computer vision tasks.

In some implementations, the image 206 captured by the HMD 204 is one image frame of a group of consecutively captured frames (e.g., a video stream). For instance, FIG. 2B illustrates image 206 in association with a particular timepoint (i.e., “timepoint 2”). FIG. 2B also depicts another image 214 associated with a different timepoint (i.e., “timepoint 1”). Image 214 also depicts features of the ball 208, box 210, and table 212 of the environment of user 202. In the example of FIG. 2B, image 214 is associated with a timepoint that precedes the timepoint associated with image 206. Image 214 may comprise an image captured by the HMD 204, or may be a composite or output image determined based upon imagery captured by the HMD 204 (e.g., based upon images captured at multiple timepoints, each of which may precede “timepoint 2” associated with image 206).

As noted above, systems may combine multiple images to form output imagery, such as when imaging under low light conditions (e.g., where each individual frame captures few photons, and combination of frames enables generation of user-interpretable output imagery). However, as also noted above, images associated with different timepoints can also be associated with different image capture positions. For instance, FIG. 2B conceptually depicts rotational movement 216 of the HMD 204 brought about by rotation of the head of the user 202 from timepoint 1 to timepoint 2. FIG. 2B also conceptually depicts translational movement 218 of the HMD 204 brought about by walking of the user 202 from timepoint 1 to timepoint 2.

The rotational movement 216 and the translational movement 218 cause differences in the depictions of the ball 208, the box 210, and the table 212 in the different images 206 and 214. For instance, image 206 provides a spatially offset and zoomed representation of the ball 208, the box 210, and the table 212 relative to the representations of the ball 208, the box 210, and the table shown in image 214. Because of the rotational and translational difference in image capture positions associated with images 206 and 214, motion compensation techniques of the present disclosure may be implemented to facilitate combination of the images 206 and 214 to form output imagery.

At least some disclosed embodiments utilize inertial tracking data (e.g., obtained via an inertial measurement unit (IMU)) to facilitate rotational motion compensation and utilize optical flow techniques to facilitate translational motion compensation (which may include compensating for both translation and zoom effects that may be caused by a user walking in an environment). FIG. 2B depicts inertial tracking data 220 captured by the HMD 204 (e.g., captured by an IMU or other sensor 110 of the HMD 204). The inertial tracking data 220 may comprise 3D rotation data representative of the rotational movement 216 experienced by the HMD 204 from timepoint 1 to timepoint 2. For instance, the inertial tracking data 220 may comprise a delta pose indicating three rotation angles (e.g., yaw, pitch, and roll) that correspond to the rotational movement 216. The inertial tracking data 220 may thus be utilized to facilitate rotation compensation.

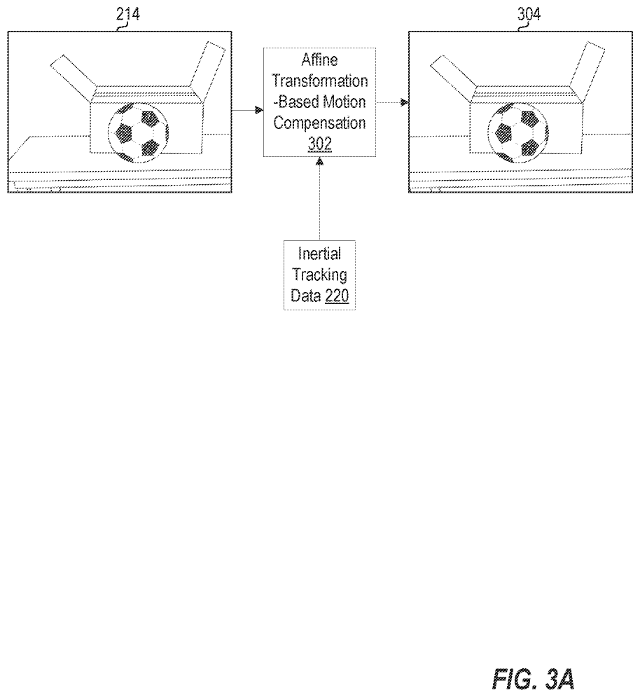

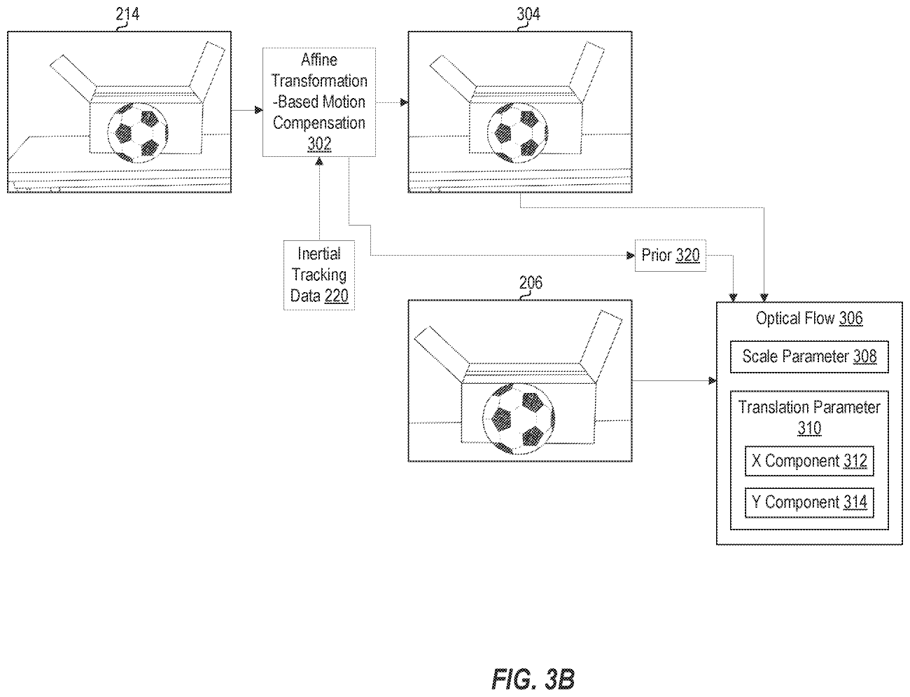

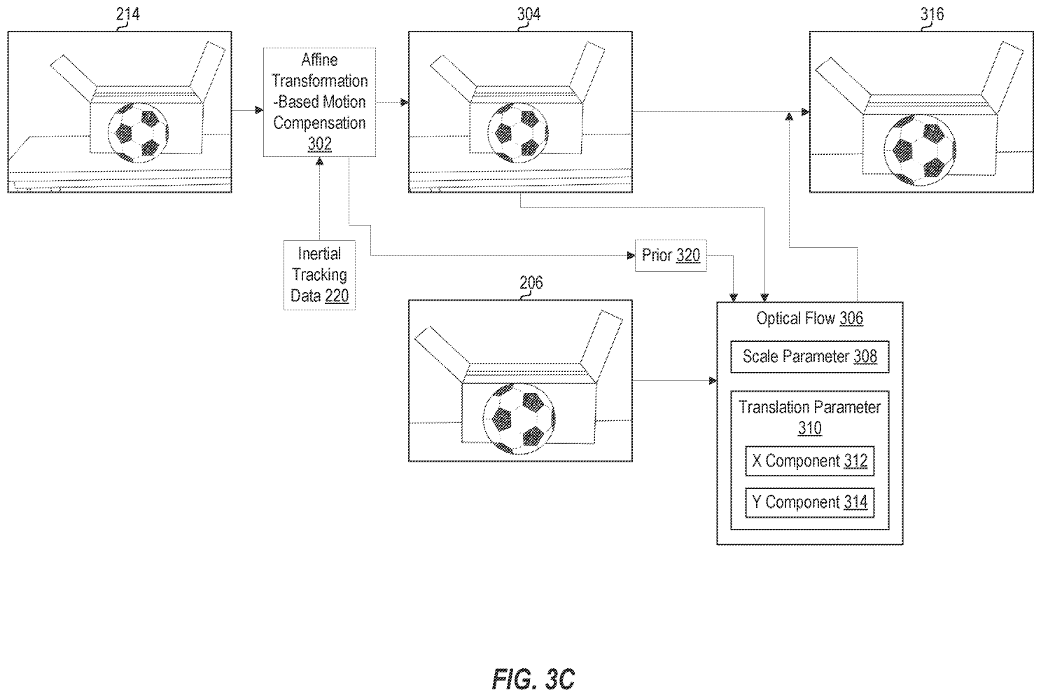

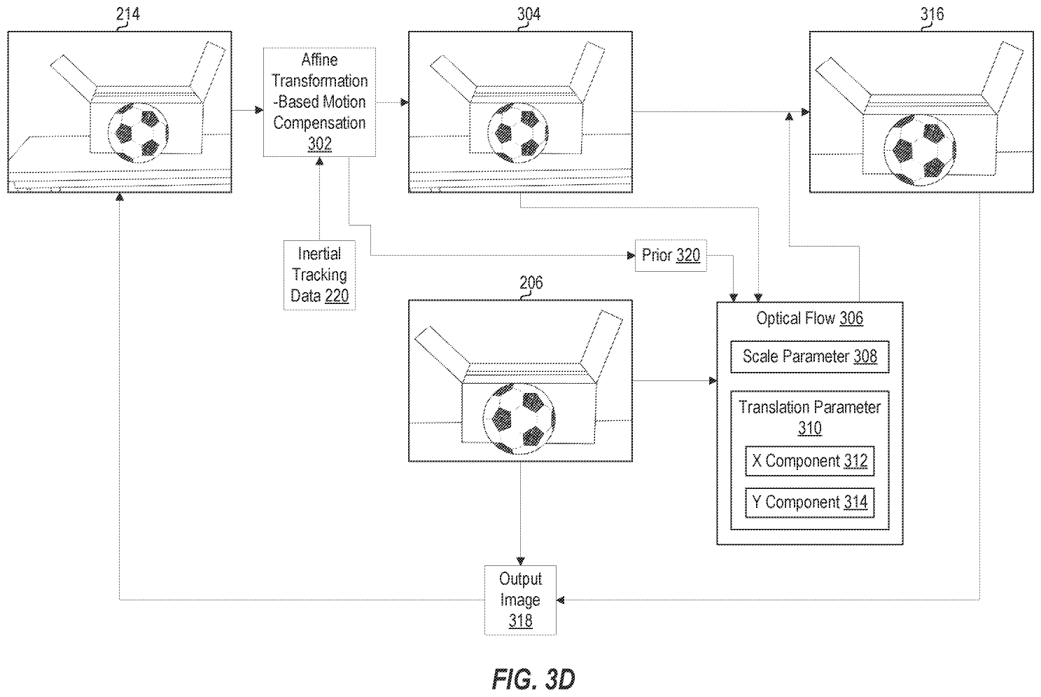

FIG. 3A illustrates a conceptual representation of applying affine transformation-based motion compensation. In particular, FIG. 3A depicts image 214 the inertial tracking data 220 discussed hereinabove with reference to FIG. 2B. FIG. 3A furthermore depicts affine transformation-based motion compensation 302 applied to image 214 using the inertial tracking data 220. In the example of FIG. 3A, the affine transformation-based motion compensation 302 provides an affine transformation-compensated image 304. As is evident from FIG. 3A, the application of the affine transformation-based motion compensation 302 spatially modifies the depictions of objects in the environment of the user 202 (relative to the depictions of such objects in image 214). For instance, in FIG. 3A, the depictions of the ball 208, the box 210, and the table 212 in the affine transformation-compensated image 304 are spatially shifted to the left relative to the depictions of such objects in image 214.

The affine transformation-based motion compensation 302 may be accomplished utilizing various techniques. In one example, the delta pose associated with the inertial tracking data 220 may be utilized to obtain a 3D rotation motion model or an affine transformation-based 2D optical flow field that describes how each individual pixel of image 214 has moved resulting from the rotational movement 216 between timepoint 1 and timepoint 2. The affine transformation-based 2D optical flow field may be obtained by selecting a set of pixel coordinates of the image 214, unprojecting the set of pixel coordinates into 3D space, rotating (in 3D space) the unprojected set of pixel coordinates using the delta pose of the inertial tracking data 220, and reprojecting the rotated unprojected set of pixel coordinates to form a new image. Each pixel of the image 214 that is unprojected and reprojected may therefore be associated with a corresponding pixel in the new image. A rotation model (e.g., an affine or other type of motion model) may be fit using the pixel correspondences between the image 214 and the new image. The rotation model may indicate the affine transformation-based 2D optical flow field for obtaining the affine transformation-compensated image 304 from the image 214. The affine transformation-compensated image 304 may be obtained by applying the rotation model (or affine transformation-based 2D optical flow field) to pixels of the image 214.

In some instances, only a sparse sampling of pixel correspondences is determined via unprojection and reprojection of pixels of the image 214, which may contribute to computational efficiency in obtaining the rotation model (or affine transformation-based 2D optical flow field) for generating the affine transformation-compensated image 304.

FIG. 3B illustrates a conceptual representation of determining optical flow 306 between the affine transformation-compensated image 304 and image 206 from FIG. 2A (e.g., using the affine transformation-compensated image 304 and image 206 as inputs). As noted above, image 206 is associated with timepoint 2, whereas affine transformation-compensated image 304 is derived from image 214, which is associated with timepoint 1. Thus, image 214 may be regarded as a first or previous image, and image 206 may be regarded as a second or current image. Although FIG. 3B depicts the raw affine transformation-compensated image 304 and image 206 being utilized as inputs for determining the optical flow 306, downscaled representations of the affine transformation-compensated image 304 and image 206 are utilized as inputs for generating optical flow 306. In some instances, utilizing downscaled images for determining optical flow can help mitigate image noise (which can be prevalent in low-light images). Downscaling may be applied to image 214 prior to determining the affine transformation-compensated image 304 (resulting in a downscaled affine transformation-compensated image), or downscaling may be applied to the affine transformation-compensated image 304 itself after computing the affine transformation-compensated image 304 at full resolution.

In the example of FIG. 3B, the optical flow 306 includes a scale parameter 308 and a translation parameter 310 and omits other motion model parameters such as rotation and shear parameters (e.g., because rotation is handled by the affine transformation-based motion compensation 302 discussed hereinabove). In this regard, the optical flow 306 may comprise components associated with a “zoom” model, which is distinct from a full 6-parameter affine model that allows modeling of rotation, shearing, translation, and scaling. Such features can enable the optical flow 306 to perform well under low signal environments by omitting parameters that can contribute to excessive flexibility in determining an optical flow solution based primarily on image noise. Such features can therefore mitigate wobble artifacts in output imagery.

The translation parameter 310 may comprise different components to model translation in two dimensions. For instance, in FIG. 3B, the translation parameter 310 includes an x component 312 and a y component 314. In this regard, the optical flow 306 may be regarded as comprising (or usable to form) a 3-parameter model: translation in the x-direction, translation in the y-direction, and scale. The parameters may be utilized to construct a motion model written as a 3×3 matrix: (s, 0, tₓ; 0, s, t_{y}; 0, 0, 1), where s represents scale, tₓ represents translation in the x-direction, and t_{y} represents translation in the y-direction.

In some instances, rather than computing a different motion model based upon optical flow 306 for every pixel of the affine transformation-compensated image 304, a single motion model (e.g., the 3×3 matrix discussed above) is used to map all pixels of the affine transformation-compensated image 304 to image 206, which may contribute to improved performance in low signal and/or high noise environments.

In some implementations, a modified version of the Lukas Kanade (LK) algorithm is utilized to obtain the optical flow 306 (e.g., the parameters thereof, which may be used to obtain a motion model that is applicable to all pixels). By way of illustration, and not limitation, the optical flow constraint may be written as:

$$gx * Δ x + gy * Δ y = - gt$$

where gx and gy refer to the spatial gradients in the x-direction and the y-direction, gt refers to the temporal gradient, Δx refers to the x-displacement vector, and Δy refers to the y-displacement vector. This optical flow constraint may be modified to obtain parameters for a “zoom” model by utilizing:

$$Δ x = s * x + {t}_{x} and Δ y = s * y + {t}_{y}$$

where s is the scale factor and tx and ty are translation values of the zoom model. The optical flow constraint can thus be rewritten as:

$$gx * ( s * x + {t}_{x} ) + gy * ( s * y + {t}_{y} ) = - gt$$

which is equivalent to:

$$( gx * x + gy * y ) * s + gx * {t}_{x} + gy * {t}_{y} = - gt .$$

One equation of the above form may be obtained for every pixel in the optical flow computation. In matrix form, this equation may be written as:

$$( \begin{matrix}gx * x + gy * y & gx & gy \\ . & . & . \\ . & . & .\end{matrix} ) ( \begin{matrix}s \\ {t}_{x} \\ {t}_{y}\end{matrix} ) = ( \begin{matrix}- gt \\ . \\ .\end{matrix} )$$

where each pixel of the optical flow computation contributes one row in the left-most matrix.

The leftmost matrix may be referred to as A, the vector (s, tₓ, t_{y})^{T} (indicating the optical flow 306 scale parameter 308, s, and translation parameters 310, tₓ, t_{y}) may be referred to as x, and the rightmost vector may be referred to as b, providing a system of equations of the form Ax=b, for which x may be found by determining the least squared error solution:

$$x = {( {A}^{T} A )}^{- 1} {A}^{T} x .$$

In the example of FIG. 3B, a prior 320 is utilized to generate the optical flow 306. FIG. 3B conceptually depicts that the prior 320 is based upon one or more components of the affine transformation-based motion compensation 302. For instance, the prior 320 may comprise or be based upon the affine transformation-based 2D optical flow field discussed hereinabove as being obtained based upon the inertial tracking data 220 and used to obtain the affine transformation-compensated image 304. In some implementations, the prior 320 biases the parameters of the optical flow 306 (or a motion model based on the parameters of the optical flow 306) toward the affine transformation-based solution or optical flow (e.g., the affine transformation-based 2D optical flow field associated with the affine transformation-based motion compensation 302).

In some implementations, the prior 320 is implemented by adding one or more equations to the modified version of the LK algorithm used to obtain the optical flow 306. Stated differently, the prior 320 may be implemented by further modifying the LK algorithm to indicate that a flow vector at a particular pixel should be identical to the corresponding affine transformation-based 2D optical flow field (or else be penalized in the computation). Weight may be added to balance the influence of the prior 320 with the rest of the modified LK algorithm when solving in a least-squares sense.

For instance, the prior 320 may be implemented by adding rows to the A matrix discussed hereinabove with reference to the modified LK algorithm for determining the optical flow 306. In some implementations, two rows are added to the A matrix for each pixel of the optical flow computation. In one example, for each pixel, the following is added to the A matrix:

$$s * x + {t}_{x} = {p}_{x} and s * y + {t}_{y} = {p}_{y}$$

where pₓ and p_{y} represent the affine transformation-based 2D optical flow solution at the pixel. The above equations may be represented in matrix form as:

$$( \begin{matrix}x & 1 & 0 \\ y & 0 & 1 \\ . & . & .\end{matrix} ) ( \begin{matrix}s \\ {t}_{x} \\ {t}_{y}\end{matrix} ) = ( \begin{matrix}{p}_{x} \\ {p}_{y} \\ .\end{matrix} ) .$$

FIG. 3C illustrates a conceptual representation of applying the optical flow 306 to the affine transformation-compensated image 304 to obtain a motion-compensated image 316. The optical flow 306 may be applied to the affine transformation-compensated image 304 by generating a motion model (e.g., a “zoom” model) using the parameters of the optical flow 306 (e.g., by forming a transformation matrix using the scale parameter 308 and the x component 312 and the y component 314) and applying the motion model to pixels of the affine transformation-compensated image 304. The motion model derived from the optical flow 306 parameters may be applied to all pixels of the affine transformation-compensated image 304 to obtain the motion-compensated image 316, in contrast with conventional optical flow techniques that derive a different motion model (or flow vector) for each pixel. Utilizing a single motion model for the entire image may contribute to reduced image artifacts, particularly in low signal and/or high noise environments.

In the example of FIG. 3C, the application of the optical flow 306 to the affine transformation-compensated image 304 causes the motion-compensated image 316 to depict a translated and scaled (or zoomed) representation of the objects represented in the affine transformation-compensated image 304. As is evident from FIG. 3C, the motion-compensated image 316 closely corresponds to the current image 206, allowing the motion-compensated image 316 and the current image 206 to be combined (e.g., via weighted averaging) to form an output image. FIG. 3D illustrates a conceptual representation of generating an output image 318 using the motion-compensated image 316 and the current image 206. The motion-compensated image 316 and the current image 206 may be combined or filtered utilizing any suitable techniques to form the output image 318.

FIG. 3D also depicts an arrow extending from the output image 318 toward the previous image 214, indicating that an output image 318 obtained by combining a motion-compensated image 316 with a current image 206 may be utilized as a previous image (in a manner similar to previous image 214) to generate a subsequent affine transformation-compensated image for a subsequent image processing iteration.

### Example Method(s)

The following discussion now refers to a number of methods and method acts that may be performed in accordance with the present disclosure. Although the method acts are discussed in a certain order and illustrated in a flow chart as occurring in a particular order, no particular ordering is required unless specifically stated, or required because an act is dependent on another act being completed prior to the act being performed. One will appreciate that certain embodiments of the present disclosure may omit one or more of the acts described herein.

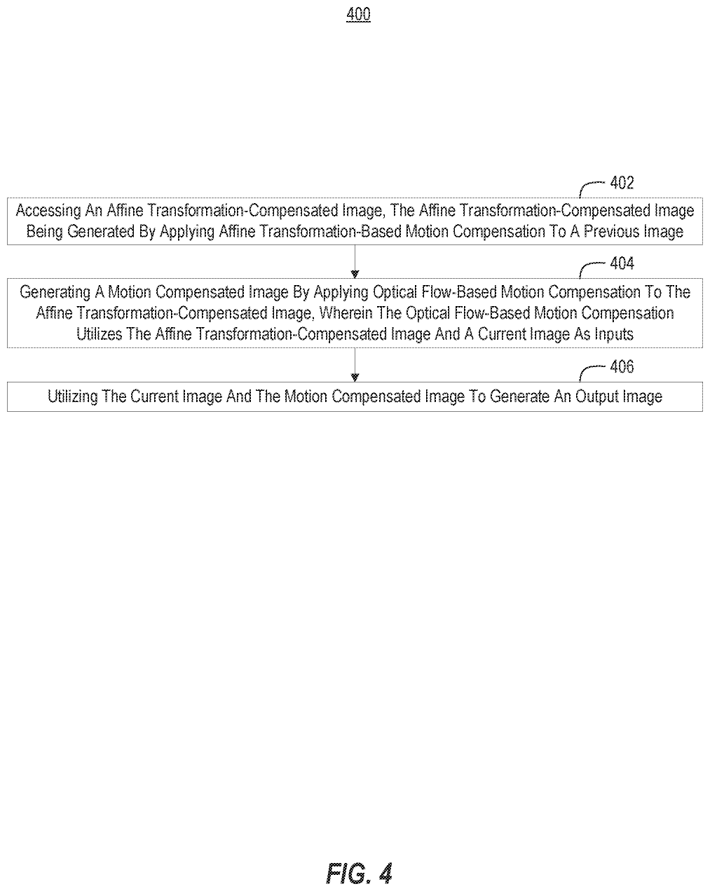

FIGS. 4, 5, and 6 illustrate example flow diagrams 400, 500, and 600, respectively, depicting acts associated with facilitating motion compensation, in accordance with implementations of the present disclosure.

Act 402 of flow diagram 400 of FIG. 4 includes accessing an affine transformation-compensated image, the affine transformation-compensated image being generated by applying affine transformation-based motion compensation to a previous image. In some instances, the affine transformation-based motion compensation utilizes inertial tracking data obtained by an IMU.

Act 404 of flow diagram 400 includes generating a motion-compensated image by applying optical flow-based motion compensation to the affine transformation-compensated image, wherein the optical flow-based motion compensation utilizes the affine transformation-compensated image and a current image as inputs. In some implementations, the affine transformation-compensated image and the current image comprise downscaled images. In some examples, the optical flow-based motion compensation comprises: (i) determining an optical flow between the affine transformation-compensated image and the current image; and (ii) applying the optical flow to the affine transformation-compensated image to obtain the motion-compensated image. In some instances, the optical flow comprises a scale parameter and a translation parameter. In some implementations, the optical flow omits rotation and shear parameters. In some examples, the translation parameter comprises a first translation component in a first dimension and a second translation component in a second dimension. In some instances, determining the optical flow utilizes a prior based upon one or more components of the affine transformation-based motion compensation. In some implementations, the prior biases the optical flow toward an affine transformation-based optical flow determined from the one or more components of the affine transformation-based motion compensation. In some examples, applying the optical flow to the affine transformation-compensated image comprises: (i) generating a motion model using the scale parameter and the translation parameter; and (ii) applying the motion model to all pixels of the affine transformation-compensated image to obtain the motion-compensated image.

Act 406 of flow diagram 400 includes utilizing the current image and the motion-compensated image to generate an output image.

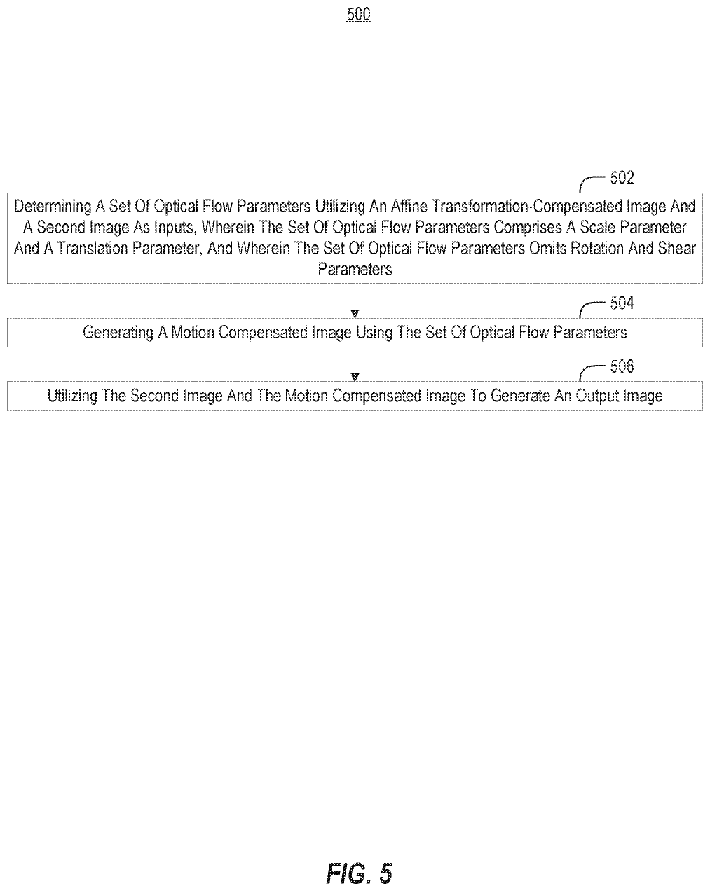

Act 502 of flow diagram 500 of FIG. 5 includes determining a set of optical flow parameters utilizing an affine transformation-compensated image and a second image as inputs, wherein the set of optical flow parameters comprises a scale parameter and a translation parameter, and wherein the set of optical flow parameters omits rotation and shear parameters. In some instances, the affine transformation-compensated image is generated based upon inertial tracking data. In some implementations, the translation parameter comprises a first translation component in a first dimension and a second translation component in a second dimension.

Act 504 of flow diagram 500 includes generating a motion-compensated image using the set of optical flow parameters. In some examples, generating the motion-compensated image comprises: (i) generating a motion model using the set of optical flow parameters; and (ii) applying the motion model to all pixels of the affine transformation-compensated image to obtain the motion-compensated image.

Act 506 of flow diagram 500 includes utilizing the second image and the motion-compensated image to generate an output image.

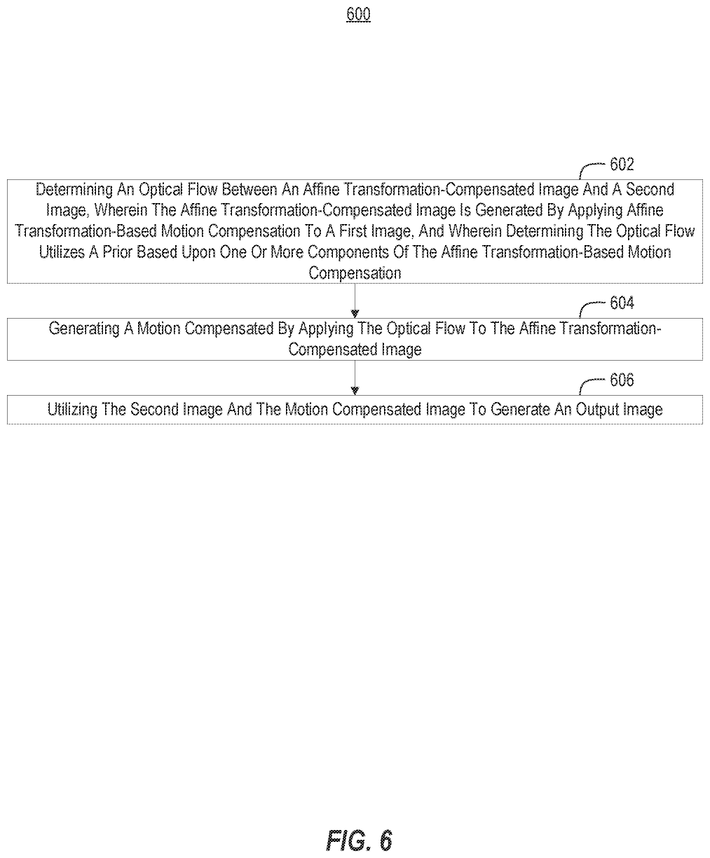

Act 602 of flow diagram 600 of FIG. 6 includes determining an optical flow between an affine transformation-compensated image and a second image, wherein the affine transformation-compensated image is generated by applying affine transformation-based motion compensation to a first image, and wherein determining the optical flow utilizes a prior based upon one or more components of the affine transformation-based motion compensation. In some instances, the prior biases the optical flow toward an affine transformation-based optical flow determined from the one or more components of the affine transformation-based motion compensation.

Act 604 of flow diagram 600 includes generating a motion compensated by applying the optical flow to the affine transformation-compensated image.

Act 606 of flow diagram 600 includes utilizing the second image and the motion-compensated image to generate an output image.

### Additional Details Related to the Disclosed Embodiments

Disclosed embodiments may comprise or utilize a special-purpose or general-purpose computer including computer hardware, as discussed in greater detail below. Disclosed embodiments also include physical and other computer-readable media for carrying or storing computer-executable instructions and/or data structures. Such computer-readable media can be any available media that can be accessed by a general-purpose or special-purpose computer system. Computer-readable media that store computer-executable instructions in the form of data are one or more “physical computer storage media” or “hardware storage device(s).” Computer-readable media that merely carry computer-executable instructions without storing the computer-executable instructions are “transmission media.” Thus, by way of example and not limitation, the current embodiments can comprise at least two distinctly different kinds of computer-readable media: computer storage media and transmission media.

Computer storage media (aka “hardware storage device”) are computer-readable hardware storage devices, such as RAM, ROM, EEPROM, CD-ROM, solid state drives (“SSD”) that are based on RAM, Flash memory, phase-change memory (“PCM”), or other types of memory, or other optical disk storage, magnetic disk storage or other magnetic storage devices, or any other medium that can be used to store desired program code means in hardware in the form of computer-executable instructions, data, or data structures and that can be accessed by a general-purpose or special-purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmission media can include a network and/or data links that can be used to carry program code in the form of computer-executable instructions or data structures, and which can be accessed by a general-purpose or special-purpose computer. Combinations of the above are also included within the scope of computer-readable media.

Further, upon reaching various computer system components, program code means in the form of computer-executable instructions or data structures can be transferred automatically from transmission computer-readable media to physical computer-readable storage media (or vice versa). For example, computer-executable instructions or data structures received over a network or data link can be buffered in RAM within a network interface module (e.g., a “NIC”), and then eventually transferred to computer system RAM and/or to less volatile computer-readable physical storage media at a computer system. Thus, computer-readable physical storage media can be included in computer system components that also (or even primarily) utilize transmission media.

Computer-executable instructions comprise, for example, instructions and data which cause a general-purpose computer, special-purpose computer, or special-purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Disclosed embodiments may comprise or utilize cloud computing. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, wearable devices, and the like. The invention may also be practiced in distributed system environments where multiple computer systems (e.g., local and remote systems), which are linked through a network (either by hardwired data links, wireless data links, or by a combination of hardwired and wireless data links), perform tasks. In a distributed system environment, program modules may be located in local and/or remote memory storage devices.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Application-specific Standard Products (ASSPs), System-on-a-chip systems (SOCs), Complex Programmable Logic Devices (CPLDs), central processing units (CPUs), graphics processing units (GPUs), and/or others.

As used herein, the terms “executable module,” “executable component,” “component,” “module,” or “engine” can refer to hardware processing units or to software objects, routines, or methods that may be executed on one or more computer systems. The different components, modules, engines, and services described herein may be implemented as objects or processors that execute on one or more computer systems (e.g., as separate threads).

One will also appreciate how any feature or operation disclosed herein may be combined with any one or combination of the other features and operations disclosed herein. Additionally, the content or feature in any one of the figures may be combined or used in connection with any content or feature used in any of the other figures. In this regard, the content disclosed in any one figure is not mutually exclusive and instead may be combinable with the content from any of the other figures.

As used herein, the term “about”, when used to modify a numerical value or range, refers to any value within 5%, 10%, 15%, 20%, or 25% of the numerical value modified by the term “about”.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope

We claim:

1. A system for facilitating motion compensation, the system comprising:
one or more processors; and
one or more hardware storage devices that store instructions that are executable by the one or more processors to configure the system to:
access an affine transformation-compensated image, the affine transformation-compensated image being generated by applying affine transformation-based motion compensation to a previous image; and
generate a motion-compensated image by applying optical flow-based motion compensation to the affine transformation-compensated image, wherein the optical flow-based motion compensation utilizes the affine transformation-compensated image and a current image as inputs.

2. The system of claim 1, further comprising an inertial measurement unit (IMU) and an image sensor that captures the previous image and the current image.

3. The system of claim 2, wherein the affine transformation-based motion compensation utilizes inertial tracking data obtained by the IMU.

4. The system of claim 1, wherein the affine transformation-compensated image and the current image comprise downscaled images.

5. The system of claim 1, wherein the optical flow-based motion compensation comprises:
determining an optical flow between the affine transformation-compensated image and the current image; and
applying the optical flow to the affine transformation-compensated image to obtain the motion-compensated image.

6. The system of claim 5, wherein the optical flow comprises a scale parameter and a translation parameter.

7. The system of claim 6, wherein the optical flow omits rotation and shear parameters.

8. The system of claim 6, wherein the translation parameter comprises a first translation component in a first dimension and a second translation component in a second dimension.

9. The system of claim 8, wherein applying the optical flow to the affine transformation-compensated image comprises:
generating a motion model using the scale parameter and the translation parameter; and
applying the motion model to all pixels of the affine transformation-compensated image to obtain the motion-compensated image.

10. The system of claim 5, wherein determining the optical flow utilizes a prior based upon one or more components of the affine transformation-based motion compensation.

11. The system of claim 10, wherein the prior biases the optical flow toward an affine transformation-based optical flow determined from the one or more components of the affine transformation-based motion compensation.

12. The system of claim 1, wherein the instructions are executable by the one or more processors to further configure the system to:
utilize the current image and the motion-compensated image to generate an output image.

13. A system for facilitating motion compensation, the system comprising:
one or more processors; and
one or more hardware storage devices that store instructions that are executable by the one or more processors to configure the system to:
determine a set of optical flow parameters utilizing an affine transformation-compensated image and a second image as inputs, wherein the set of optical flow parameters comprises a scale parameter and a translation parameter, and wherein the set of optical flow parameters omits rotation and shear parameters; and
generate a motion-compensated image using the set of optical flow parameters.

14. The system of claim 13, wherein the affine transformation-compensated image is generated based upon inertial tracking data.

15. The system of claim 13, wherein the translation parameter comprises a first translation component in a first dimension and a second translation component in a second dimension.

16. The system of claim 13, wherein generating the motion compensated image comprises:
generating a motion model using the set of optical flow parameters; and
applying the motion model to all pixels of the affine transformation-compensated image to obtain the motion-compensated image.

17. The system of claim 13, wherein the instructions are executable by the one or more processors to further configure the system to:
utilize the second image and the motion-compensated image to generate an output image.

18. A system for facilitating motion compensation, the system comprising:
one or more processors; and
one or more hardware storage devices that store instructions that are executable by the one or more processors to configure the system to:
determine an optical flow between an affine transformation-compensated image and a second image, wherein the affine transformation-compensated image is generated by applying affine transformation-based motion compensation to a first image, and wherein determining the optical flow utilizes a prior based upon one or more components of the affine transformation-based motion compensation; and
generate a motion-compensated image by applying the optical flow to the affine transformation-compensated image.

19. The system of claim 18, wherein the prior biases the optical flow toward an affine transformation-based optical flow determined from the one or more components of the affine transformation-based motion compensation.

20. The system of claim 18, wherein the instructions are executable by the one or more processors to further configure the system to:
utilize the second image and the motion-compensated image to generate an output image.
